(19) United States
(12) Patent Application Publication
(10) Pub. No.: US 2014/0250029 A1
(43) Pub. Date: Sep. 4, 2014

(54) SUPPORT SYSTEM AND COMPUTER READABLE NON-TRANSITORY RECORDING MEDIUM HAVING PROGRAM RECORDED THEREON

(71) Applicant: Hideaki Komata, (US)

(72) Inventor: Katsuyuki Kato, Kitanagoya-shi (JP)

(73) Assignee: Hideaki KOMATA, Tokyo (JP)

(21) Appl. No.: 13/783,843

(22) Filed: Mar. 4, 2013

(51) Int. Cl. G06Q 40/00

(52) U.S. Cl. CPC G06Q 40/00
USPC 705/36 R

(57) ABSTRACT

A support system includes a display device that includes a display screen, a storage device, and a processing device that is connected to the display device and the storage device and that causes the display device to carry out processing to display an indicator display section on the display screen, the indicator display section displaying an indicator that indicates a price reversal timing within a predetermined period with time on the horizontal axis based on information stored in the storage device indicating the price reversal timing, and being configured, when being displayed to be superimposed on another image displayed on the display screen, to allow the other image to be visible through the indicator display section.

### BACKGROUND OF THE INVENTION

1. Field of the Invention

The present invention relates to a support system that supports in determining a trading opportunity of a target for speculation such as stocks, bonds, currencies, and products and to a computer readable non-transitory recording medium having recorded thereon a program for supporting in determining a trading opportunity of a target for speculation.

2. Description of the Related Art

Described in JP No. 2003-132214 A is a market information display system that displays, in order to grasp a trend in an overall market, in a predetermined layout on a flat screen, a pattern proportion display section in which time series data on individual issues that constitute the market are classified into a plurality of time series patterns, and the proportion of the issues that corresponds to that time series pattern for each of the entire time series patterns is indicated with a colored area, and a chart pattern display section that displays a chart for that time series pattern.

However, with the aforementioned existing market information display system, while it is possible to grasp a trend in an overall market, there is a problem in that it is difficult to determine a trading opportunity as to when to actually buy or sell individual issues. In particular, as one method for investing in stocks, there is a method called scalping, in which trading of stocks is repeated little by little along with up and down undulating movements in stock prices. Although this method is effective in avoiding losses, there is a problem in that it is difficult not to miss a trading opportunity that appears a plurality of times in a short period of time.

### SUMMARY OF THE INVENTION

The present invention has been made to solve the above-described problem, and it is an object of the present invention to provide a support system that makes it possible to determine a trading opportunity of a target for speculation with ease.

A support system of the present invention supports in making a determination of a trading opportunity of a target for speculation and includes a display device that includes a display screen, a storage device, and a processing device that is connected to the display device and the storage device and that causes the display device to carry out processing to display an indicator display section on the display screen, the indicator display section displaying an indicator that indicates a price reversal timing within a predetermined period with time on the horizontal axis based on information stored in the storage device indicating the price reversal timing, and being configured, when being displayed to be superimposed on another image displayed on the display screen, to allow the other image to be visible through the indicator display section.

According to the above, when an image such as a stock price chart distributed by a securities firm showing a trend of the price of a target for speculation with time on the horizontal axis is viewed through the indicator display section, it appears as if an indicator that indicates a price reversal timing is pasted on the image. Thus, it becomes easier to recognize when the price reversal timing arrives, and a trading opportunity can be determined with ease.

In the above-described support system of the present invention, it is preferable to further include a communication device that receives price information of the target for speculation via a communication line. In such a support system, it is preferable that the processing device is connected to the communication device and causes the display device to carry out processing to display on the display screen an image, as the other image, that shows a trend of the price of the target for speculation within the predetermined period with time on the horizontal axis based on the price information received by the communication device.

According to the above, an image such as a stock price chart distributed by a securities firm showing a trend of the price of a target for speculation within a predetermined period with time on the horizontal axis can be viewed through the indicator display section. Therefore, it appears as if an indicator that indicates a price reversal timing is pasted on that image. Thus, it becomes easier to recognize when the price reversal timing arrives, and a trading opportunity can be determined with ease.

In the above-described support system of the present invention, it is preferable that the indicator display section is configured such that the size and the display position thereof, respectively, in the display screen can be modified.

According to the above, the size and the display position of the indicator display section can be modified in accordance with the size and the display position of the other image, which is an object on which the indicator display section is superimposed. Thus, although a stock price chart may, for example, vary in its overall size and display position depending on a distributing party, the indicator display section is compatible with a variety of such stock price charts.

A computer readable non-transitory recording medium having a program recorded thereon of the present invention is characterized in that the program causes a computer that includes a display screen to execute processing to display an indicator display section on the display screen, and the indicator display section displays an indicator that indicates a price reversal timing of a target for speculation within a predetermined period with time on the horizontal axis, and is configured when being displayed to be superimposed on another image displayed on the display screen to allow the other image to be visible through the indicator display section.

When the recording medium is read by the computer to install the program onto the computer and an image such as a stock price chart distributed by a securities firm showing the price of a target for speculation with time on the horizontal axis is viewed through the indicator display section, it appears as if an indicator that indicates a price reversal timing is pasted on that image. Thus, it becomes easier to recognize when the price reversal timing arrives, and a trading opportunity can be determined with ease.

In the above-described computer readable non-transitory recording medium having the program recorded thereon of the present invention, it is preferable that the indicator display section is configured such that the size and the display position thereof, respectively, in the display screen can be modified.

According to the above, the size and the display position of the indicator display section can be modified in accordance with the size and the display position of the other image, which is an object on which the indicator display section is superimposed. Thus, although a stock price chart may, for example, vary in its overall size and display position depending on a distributing party, the indicator display section is compatible with a variety of such stock price charts.

### BRIEF DESCRIPTION OF THE DRAWINGS

FIG. 1 is a block diagram showing a configuration of a support system according to an embodiment of the present invention;

FIG. 2 is a diagram showing a time base display form according to the embodiment;

FIG. 3 is a diagram showing a display screen on which a Web page that includes a chart display section is displayed according to the embodiment;

FIG. 4 is a diagram showing a display screen on which the time base display form of FIG. 2 and the Web page of FIG. 3 are displayed concurrently;

FIG. 5 is a flowchart showing time base display processing according to the embodiment;

FIG. 6 is a flowchart showing screen drawing processing according to the embodiment;

FIG. 7 is a diagram showing a display screen when the time base display form is moved from the state shown in FIG. 4;

FIG. 8 is a diagram showing a display screen when the size of the time base display form is modified from the state shown in FIG. 7;

FIG. 9 is a diagram showing a display screen when time has elapsed since the state shown in FIG. 8;

FIG. 10 is a diagram showing a display screen when trading hours of the day has elapsed since the state shown in FIG. 9;

FIG. 11 is a diagram showing a menu section when only one-time base display form is to be displayed according to the embodiment;

FIG. 12 is a diagram showing a menu section when two-time base display forms are to be displayed according to the embodiment; and

FIG. 13 shows an example of a display screen on which two-time base display forms are displayed.

### DESCRIPTION OF THE PREFERRED EMBODIMENT

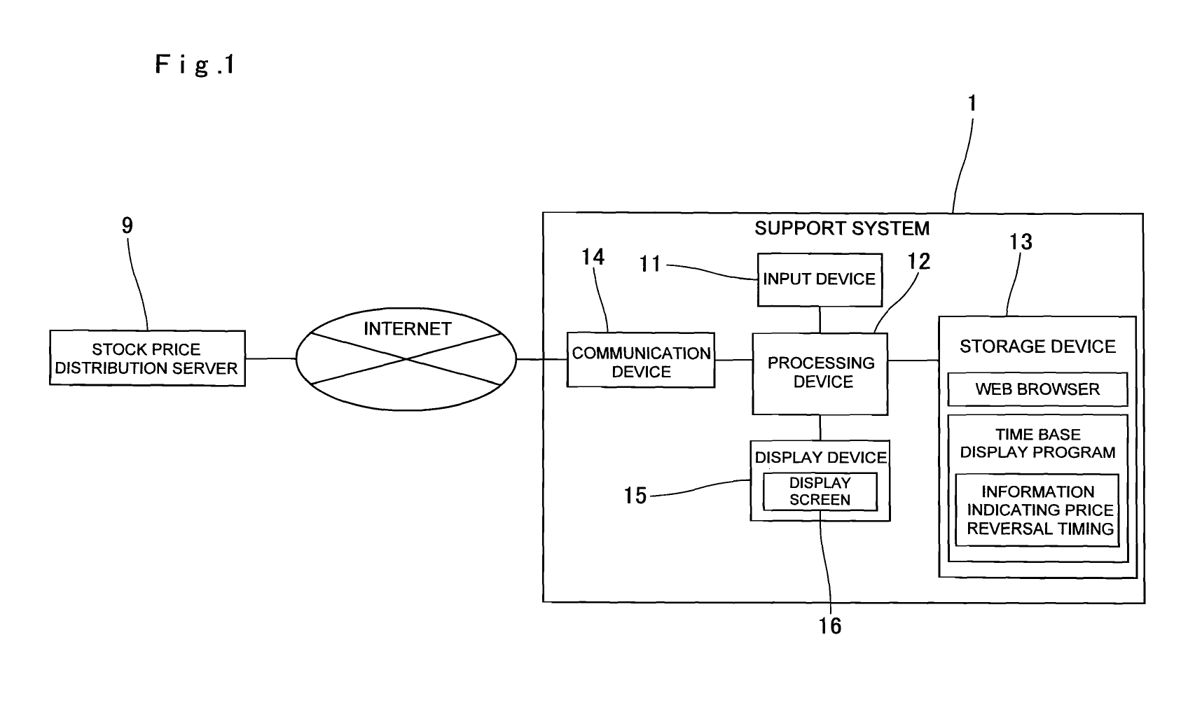

A support system 1 according to an embodiment of the present invention is used to make a determination in stock trading based on a current time, which moves along a time base (i.e., a time axis) as a trajectory, arriving at a price reversal timing (i.e., a reversal point) that lies on the time base. The support system 1 is configured of a computer, or more specifically, a personal computer, and includes, as shown in FIG. 1, an input device 11, a processing device 12, a storage device 13, a communication device 14, and a display device 15. The support system 1 is connected to a stock price distribution server 9 via the Internet. The stock price distribution server 9 is configured of a computer that distributes stock price information of each issue on a stock market and is provided at a securities firm.

The input device 11 is configured of a pointing device such as a mouse, a keyboard, and so forth and inputs to the processing device 12 various pieces of information, various instructions, and the like in accordance with an operation by a user.

The processing device 12 is configured of a CPU, a RAM that serves as a work area for the CPU, a ROM that has fixed data stored thereon, and so forth. The processing device 12 is connected to the input device 11, the storage device 13, the communication device 14, and the display device 15.

The storage device 13 is configured of a semiconductor memory, a hard disk device, a compact disk device, and so forth.

The communication device 14 is connected to a communication line, and the communication line is connected to the Internet. The communication device 14 receives price information of a stock that is a target for speculation from the stock price distribution server 9 via the Internet.

The display device 15 is configured of a liquid crystal display or the like. The display device 15 includes a display screen 16 that serves as a display surface on which an image is displayed and displays various images on the display screen 16 in accordance with a display instruction from the processing device 12. The display device 15 displays, on the display screen 16, a chart display section 31 to be described later based on the price information received by the communication device 14, and on the display screen 16, an indicator display section 21 to be described later.

As an operating system (OS), Windows (registered trademark of Microsoft Corporation) is installed on the support system 1, and a time base display program and a Web browser that operate on Windows are installed on the support system 1.

The time base display program is a program to be used to make a determination of a trading point with the time base serving as a trajectory, and is stored in the storage device 13 as the program is loaded from a computer readable non-transitory recording medium in which the program has been stored. Examples of such computer readable non-transitory recording media include a CD-ROM and a USB flash memory.

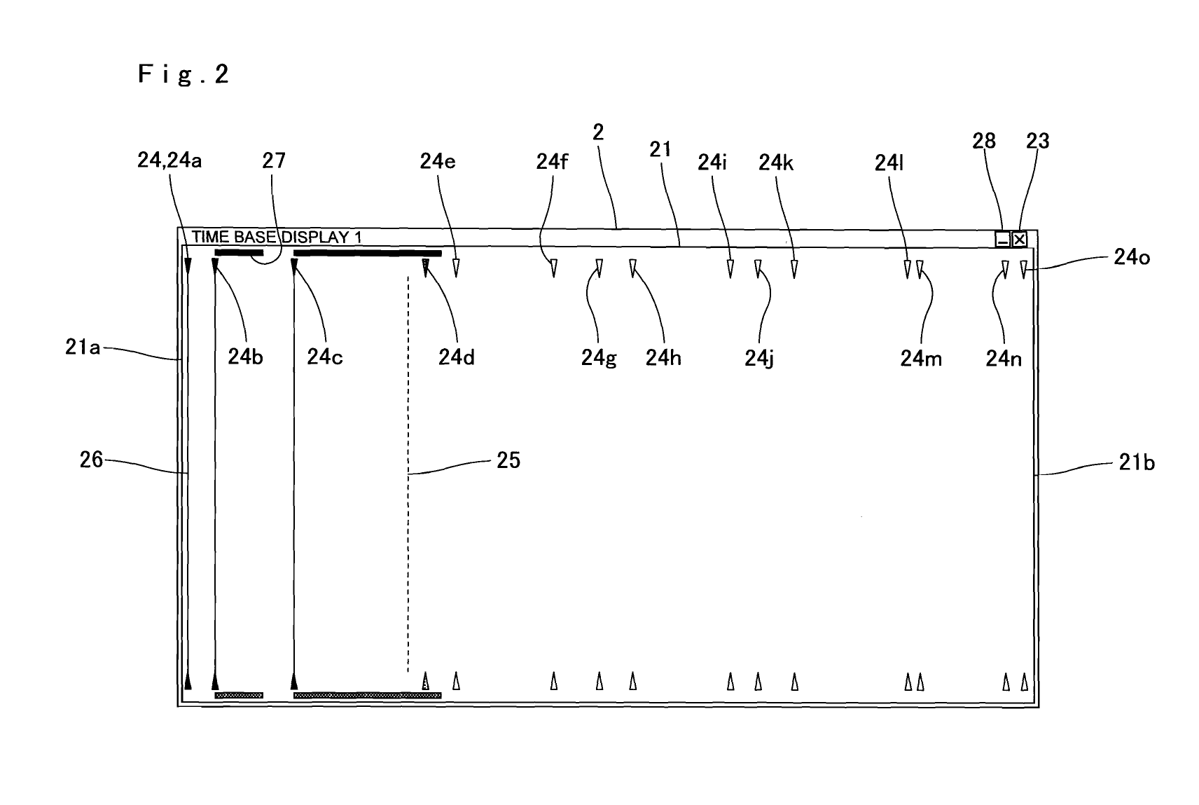

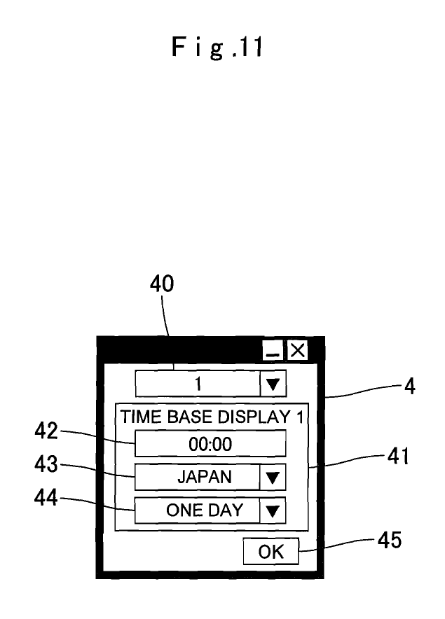

The time base display program is an application program that has been created using Windows Forms of Visual Studio (trademark or registered trademark of Microsoft Corporation). The time base display program is configured to display a menu section 4 as shown in FIG. 11 at startup and to display a time base display form 2 as shown in FIG. 2 in accordance with content selected by the user through the menu section 4. Windows Forms is software for creating an application program that displays a form (window) such as the menu section 4 and the time base display form 2. Windows Forms is capable of placing objects called controls such as various buttons and text boxes in a form to be displayed and is capable of setting various properties on the entire form and controls placed in the form.

In the time base display form 2, by setting the size property of the form (Form Border Style property) to “sizable,” the size can be made modifiable (i.e., enlarged or reduced). By setting the transparency property of the form (Opacity property) to “0.0 (completely transparent),” the background color (ground color) of the indicator display section 21 provided in the time base display form 2 is made transparent, and thus an image behind the indicator display section 21 on the display screen 16 becomes visible. That is, even when the indicator display section 21 is displayed to be superimposed on another image displayed on the display screen 16, the other image is visible through the indicator display section 21 (i.e., through the background portion). In addition, the time base display form 2 has a button 28 provided therein to minimize the time base display form 2 (i.e., for not being displayed on the display screen 16).

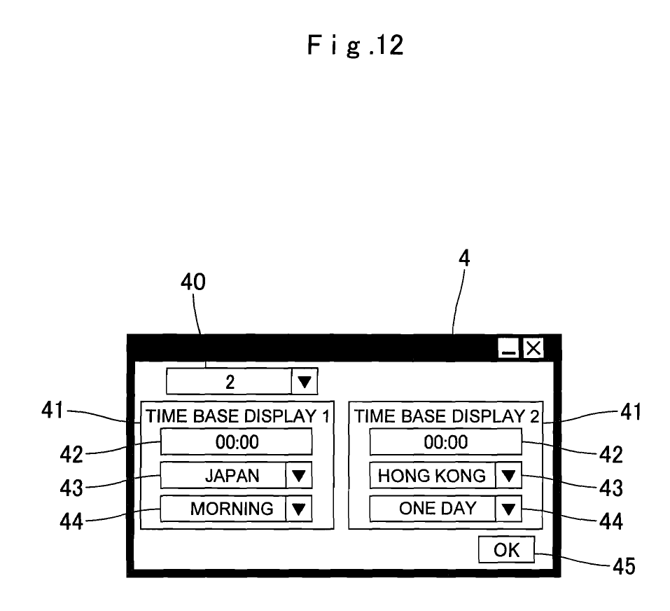

The size of the menu section 4 can be modified, but the background color thereof is set opaque, and thus an image behind the menu section 4 is not visible through the menu section 4. The menu section 4 has a display number selecting section 40 provided therein to select the number of time base display forms 2 to be displayed on the display screen 16, and a type setting section 41 is provided in accordance with the number selected through the display number selecting section 40. That is, when the menu section 4 is first displayed, “1” is selected through the display number selecting section 40 as shown in FIG. 11, and only one type setting section 41 is displayed. When “2” is selected through the display number selecting section 40 as shown in FIG. 12, however, another type setting section 41 is additionally displayed, and thus two type setting sections 41 are displayed.

The type setting section 41 is for setting a type of the time base display form 2 and includes a region selecting section 43 to select a region, a period selecting section 44 to select a period, a countdown section 42 to display time from a current time until a subsequent price reversal timing within a selected period in a selected region, and a button 45 to confirm the selections. The region selecting section 43 is for selecting a region to define time in a market where a target for speculation is traded, and “Japan,” “Hong Kong,” and so forth can be selected. The period selecting section 44 is for selecting a period expressed by a width W of the indicator display section 21, and one day, the morning (morning session), or the afternoon (afternoon session) can be selected. However, since there is a region where the session is not divided into the morning and the afternoon, the period selecting section 44 is configured such that periods from which a selection can be made differ depending on a region selected through the region selecting section 43.

A form displayed by an application program created by Windows Forms is movable on the display screen 16, and thus the menu section 4 and the time base display form 2 are movable on the display screen 16, that is, display positions thereof can be modified.

Further, with Windows Forms, it is possible to program a program (i.e., event procedure) to be executed when an event occurs as a user carries out some operation, some condition is satisfied, or the like and to include such a program in an application program to be created. The time base display program is configured such that time base display processing to be described later is carried out through event procedures at startup, when the number of the time base display forms 2 to be displayed is increased through the menu section 4, when the type of the time base display form 2 is modified through the menu section 4, when an operation to restore the minimized time base display form 2 is carried out, when an operation to move the time base display form 2 is carried out, when an operation to modify the size of the time base display form 2 (i.e., increasing or decreasing the size) is carried out, and for every predetermined period (every 0.1 second in this example).

The Web browser is Internet Explorer (trademark or registered trademark of Microsoft Corporation) and is stored in the storage device 13.

An operation of the support system 1 configured as the above will now be described.

The user starts up the Web browser to access the stock price distribution server 9 and requests stock price information of a certain issue (“xx corporation” in this example). Then, the stock price distribution server 9 sends a Web page 3 that includes the requested stock price information (to be more precise, data and a program to display the Web page 3). Stock price information provided by a securities firm or the like is typically configured to be viewed in a chart form, and the stock price distribution server 9 also sends data in a format that allows the stock price information to be displayed in a chart with time on the horizontal axis.

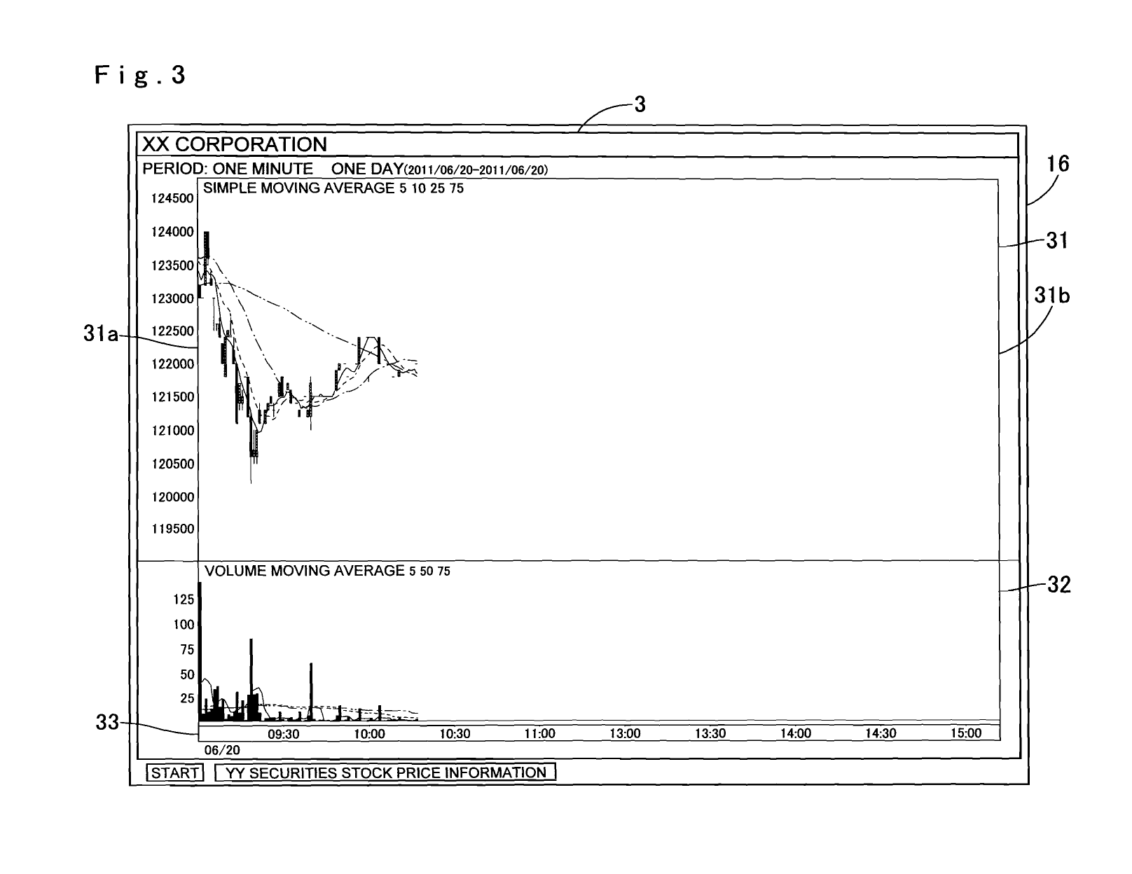

The communication device 14 of the support system 1 receives the Web page 3 that includes the stock price information from the stock price distribution server 9 via the Internet. The processing device 12 instructs the display device 15 to display the received Web page 3. The display device 15 then displays, on the display screen 16, the Web page 3 that includes the chart display section 31, a volume display section 32, and a time display section 33 as shown in FIG. 3. On the chart display section 31, stock price information for the day is displayed in a chart with time on the horizontal axis based on the received stock price information. The chart display section 31 corresponds to an image that shows a trend of the price of a target for speculation (stock in this example) within a predetermined period (one day in this example) with time on the horizontal axis. Here, an assumption is that stock price information of “xx corporation” for the day is requested at around 10:15 a.m. on Jun. 20, 2011. Thus, on the chart display section 31 shown in FIG. 3, the stock price information from 9:00 a.m., which is the opening time of the stock market on that day, to around 10:15 a.m., which is the current time, is shown in a chart. The chart in the chart display section 31 has time on the horizontal axis and the stock price on the vertical axis. A left end 31a of the chart display section 31 corresponds to the opening time of the stock market, and a right end 31b corresponds to the closing time of the stock market. The volume display section 32 is displayed below the chart display section 31 such that the time therein matches that in the chart display section 31. Trading hours for the day of the stock market where the stock shown in FIG. 3 is traded is from 9:00 to 11:00 and from 12:30 to 15:00, and the time display section 33 is displayed below the volume display section 32 to display the time horizontally (right and left direction) with a period from 11:00 to 12:30 being excluded. Note that the morning session is from 9:00 to 11:00 and the afternoon session is from 12:30 to 15:00.

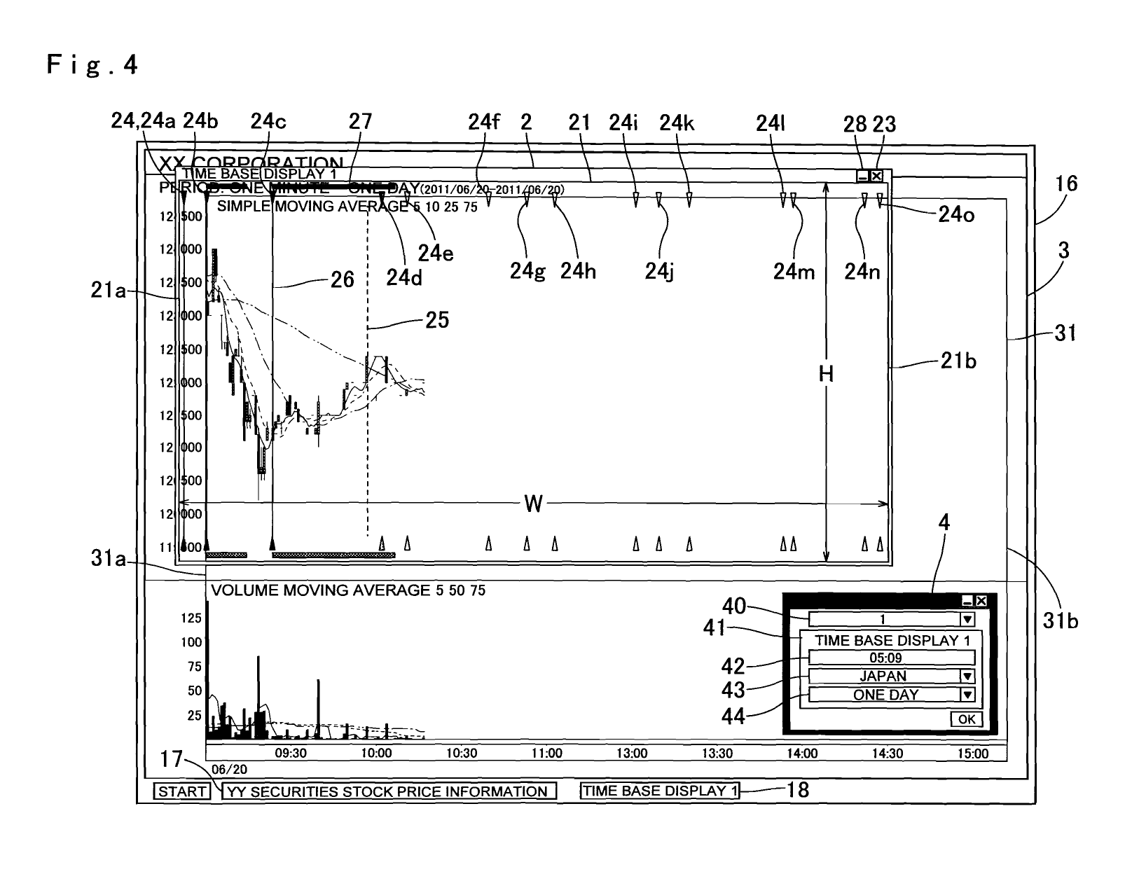

In a state where the Web page 3 is displayed, when the user starts up the time base display program, the processing device 12 of the support system 1 instructs the display device 15, in accordance with the time base display program, to display the menu section 4 and the time base display form 2 as shown in FIG. 4. The display device 15 then displays the menu section 4 on the display screen 16 and also displays, on the display screen 16, the time base display form 2 in accordance with the region and the period (“Japan” and “one day,” respectively, in this example) set as defaults (initial values) in the menu section 4. The Web page 3, the time base display form 2, and the menu section 4 are respectively separate windows and thus can be displayed to be superimposed on one another through the Windows function. When the time base display program is started in a state where the Web page 3 is displayed on the entire screen as shown in FIG. 3, the time base display form 2 and the menu section 4 are displayed in front of the Web page 3 as shown in FIG. 4. Further, since the background color of the indicator display section 21 of the time base display form 2 is transparent as described above, what is behind the indicator display section 21 is visible therethrough. In FIG. 4, the chart display section 31 is behind the indicator display section 21, and thus the chart display section 31 is visible through the indicator display section 21. However, when the indicator display section 21 is displayed as the time base display program is started, it is not necessarily the case that the position of a left end 21a of the indicator display section 21 coincides with the position of the left end 31a of the chart display section 31, as shown in FIG. 4.

In a state where Internet Explorer is started to allow the Web page 3 to be displayed, a task bar 17 is displayed on the display screen 16 through the Windows function, and in a state where the time base display program is started to allow the time base display form 2 to be displayed, a task bar 18 is displayed on the display screen 16 through the Windows function. Then, when the task bar 17 is clicked on, the Web page 3 is displayed in front of the time base display form 2, and when the task bar 18 is clicked on, the time base display form 2 is displayed in front of the Web page 3. Further, when the button 28 in the time base display form 2 is clicked on to minimize (hide) the time base display form 2, clicking on the task bar 18 causes the time base display form 2 to be displayed again at the same size as that prior to being minimized.

The time base display form 2 is provided with the indicator display section 21, and on the indicator display section 21, although the time is not directly displayed, a plurality of indicators 24 that indicate price reversal timings and a line 25 that indicates the current time are displayed with time on the horizontal axis. Note that the phrase “time on the horizontal axis” means that “the time base as the horizontal direction,” and the time base does not necessarily need to be displayed on the indicator display section 21.

Note that each price reversal timing is something which the present inventor has acquired knowledge of by analyzing trends in the stock market. That is, the present inventor has found that regardless of an issue, stock prices reverse at substantially fixed times within a day's trading (that is, a stock price that has been rising turns downward, or a stock price that has been falling turns upward). It is speculated that this finding that “the price of a target for speculation reverses at substantially fixed times within a predetermined period” is applicable even when the target for speculation is other than the stock and when the predetermined period is set to not one day but to one week or one year. Therefore, by applying a price reversal timing that is determined based on this finding to the trend of the price of a target for speculation, a trading opportunity can be determined with ease. The support system 1 is capable of superimposing an image that shows each price reversal timing determined based on this finding onto an image that shows a trend of the price of a target for speculation on the display screen 16.

The time base display form 2 will now be described in detail. The plurality of indicators 24 and a red line 25 are displayed on the indicator display section 21, in which the left end 21a of the indicator display section 21 lies at the opening time of the stock market within a period selected through the period selecting section 44 (in this example, one day, that is, from 9:00 to 11:00 and from 12:30 to 15:00) and the right end 21b lies at the closing time of the stock market within the same period with time on the horizontal axis. Each of indicators 24 includes a pair of vertically aligned triangles that indicate a price reversal timing within the aforementioned period (in this example, to identify each of the indicators 24, reference characters 24a, 24b, . . . are given in chronological order as shown in FIGS. 2 and 4). The line 25 indicates the current time. A price reversal timing appears multiple times within a day. Regardless of the issue, each price reversal timing is fixed, and the indicators 24 are displayed on respective positions that correspond to the price reversal timings. Note that the line 25 is shown by a broken line in the figure. The indicators 24a, 24b, and 24c that indicate the price reversal timings which the current time has passed (located to the left of the line 25 in the figure) are shown in black and the vertically aligned triangles thereof are connected with gray lines 26, respectively. Of the price reversal timings which the current time has not passed, the indicator 24d that is closest to the current time is displayed with the upper triangle shown in red and the lower triangle shown in blue, and further when the indicator 24d is within one minute from the current time, the indicator 24d is displayed to blink. The remaining indicators 24e, 24f, 24g, 24h, 24i, 24j, 24k, 24l, 24m, 24n, and 24o are displayed in yellow.

In addition, an indicator 27 that includes a pair of vertically aligned bars (horizontally elongated rectangles) that respectively have different colors is displayed in the indicator display section 21. The indicator 27 indicates a lowest price zone (i.e., a time period in which it is likely to hit the lowest price) and a highest price zone (i.e., a time period in which it is likely to hit the highest price) within the morning session. Depending on which of the upper and lower bars of the indicator 27 the opening price is closer to, a direction of the market thereafter (i.e., whether it goes up or down) can be speculated, and thus a stance when entering into trading (i.e., whether to start from buying or selling) can be determined. For example, if the opening price starts near the upper indicator 27, a determination is that the price falls until the subsequent price reversal timing, and if the opening price starts near the lower indicator 27, a determination is that the price rises until the subsequent price reversal timing. Accordingly, trading can be carried out while watching the current time indicated by the line 25. Further, since the indicator 27 indicates the lowest price zone and the highest price zone, the indicator 27 can also be used to lock in a profit. Note that an indicator 27 that indicates the lowest price zone and the highest price zone in the afternoon session may be displayed, or an indicator 27 that indicates the lowest price zone and the highest price zone throughout the day may be displayed.

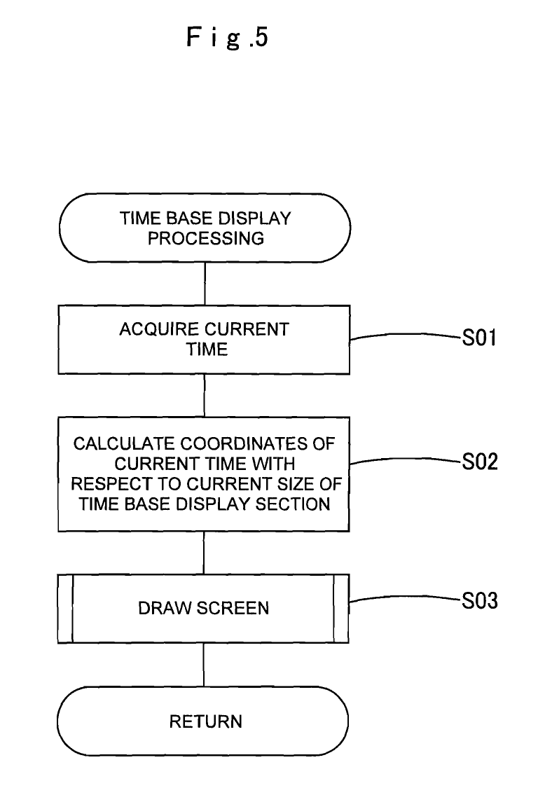

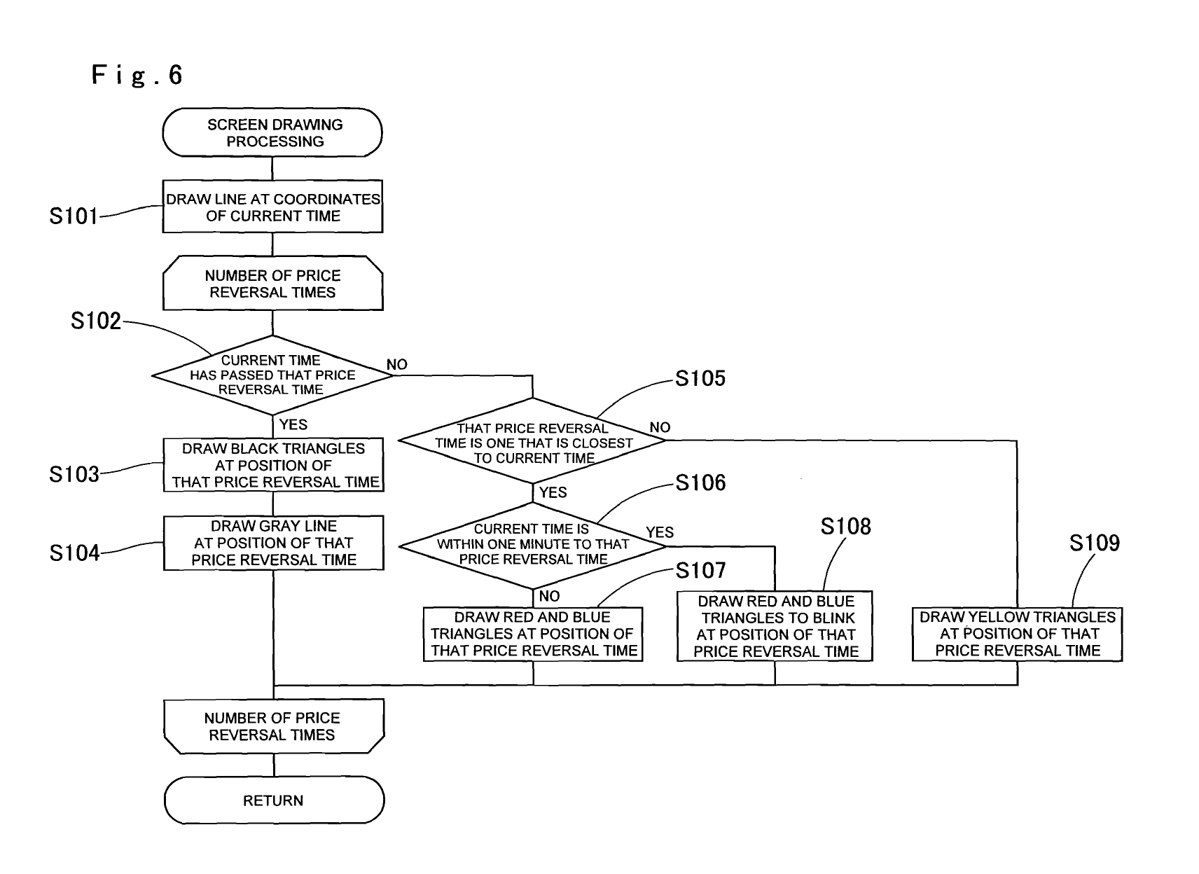

Here, an operation through which the support system 1 displays the indicators 24 and so forth in the indicator display section 21 will be described. As described above, the time base display program is configured to carry out the time base display processing that is an event procedure in a flow shown in FIGS. 5 and 6 at startup and so forth.

First, the processing device 12 of the support system 1 acquires the current time from an embedded clock (step S01 of FIG. 5). Subsequently, the processing device 12 calculates the coordinate of the current time with respect to the current size of the indicator display section 21 (step S02). That is, a calculation as to which position the current time corresponds within the indicator display section 21 in the horizontal direction is made with the width W of the indicator display section 21 being a period selected through the period selecting section 44 and with the left end 21a of the indicator display section 21 being the opening time of the stock market in the same period. Then, the processing device 12 carries out screen drawing processing (Step S03). Here, the period selected through the period selecting section 44 is “one day,” and the region selected through the region selecting section 43 is “Japan.” Further, the clock embedded in the processing device 12 is set according to Japan time. Therefore, when the region selected through the region selecting section 43 is “Japan,” the processing device 12 sets the time acquired from the embedded clock as the current time. On the other hand, when a region other than “Japan” is selected, the processing device 12 adds or subtracts time determined in advance in accordance with the selected region to or from the time acquired from the embedded clock to calculate the current time in the selected region.

In the screen drawing processing, the processing device 12 causes the display device 15 to carry out processing to draw the line 25 at a position that corresponds to the current time in the indicator display section 21 (step S101 of FIG. 6). The position of the line 25 in the vertical direction can, for example, be determined through a method in which a reference height of the indicator display section 21 and the coordinates of the upper end point and the lower end point of the line 25 within the indicator display section 21 in the vertical direction with respect to the aforementioned reference height are determined in advance, and based on a ratio of a current height H of the indicator display section 21 to the reference height, the coordinates of the upper end point and the lower end point of the line 25 in the vertical direction with respect to the height H are calculated.

Subsequently, the processing device 12 carries out processing in steps S102 to S109 for each price reversal timing. Here, since each price reversal timing in the day's trading appears at a fixed time, that time is indicated as “price reversal time” in FIG. 6 and is referred to as the “price reversal time” as well in the description based on FIG. 6, hereinafter. The time base display program has each price reversal time as a fixed value (constant), and these fixed values correspond to information that indicates the price reversal timings. That is, the support system 1 stores, in the storage device 13, the fixed values as information that indicates the price reversal timings, and the support system 1 carries out the processing in steps S102 to S109 for the number of times corresponding to the number of price reversal times (15 in this example) based on the information that indicates the price reversal timings stored in the storage device 13. Although the price reversal times may be processed in any order, they are processed in chronological order here.

First, the processing device 12 determines whether or not the current time has passed the first price reversal time, that is, the price reversal time indicated by the indicator 24a (step S102). If the current time has passed that price reversal time, the processing device 12 proceeds to step S103, and if the current time has not passed that price reversal time, the processing device 12 proceeds to step S105. In the example shown in FIGS. 2 and 4, the current time has passed the price reversal time indicated by the indicator 24a. Thus, the processing device 12 proceeds to step S103 and causes the display device 15 to carry out processing to draw the indicator 24a configured of a pair of vertically aligned black triangles at the position of that price reversal time in the indicator display section 21. Then, the processing device 12 proceeds to step S104 and causes the display device 15 to carry out processing to draw a gray line 26 to connect the vertically aligned triangles at the position of that price reversal time. Note that the position of the price reversal time in the indicator display section 21 is calculated based on the fixed value that indicates that price reversal time, similar to the case where the current time has been calculated. Then, the processing device 12 returns to step S102 and determines whether or not the current time has passed a subsequent price reversal time, that is, the price reversal time indicated by the indicator 24b. For the price reversal times indicated by the respective indicators 24b and 24c, similar to the indicator 24a, black triangles and gray lines 26 are drawn.

Subsequently, the processing device 12 determines whether or not the current time has passed the price reversal time indicated by the indicator 24d (step S102). Since the current time has not passed that price reversal time, the processing device 12 proceeds to step S105 and determines whether or not the price reversal time indicated by the indicator 24d is the price reversal time that is closest to the current time. Then, since that price reversal time is the price reversal time that is closest to the current time, the processing device 12 proceeds to step S106 and determines whether or not the current time is within one minute to that price reversal time. If the current time is not within one minute to that price reversal time, the processing device 12 causes the display device 15 to draw the indicator 24d including a pair of vertically aligned triangles with the upper triangle shown in red and the lower triangle shown in blue in the indicator display section 21 at a position corresponding to that price reversal time (step S107). On the other hand, if the current time is within one minute to that price reversal time, the indicator 24d is drawn to blink with the upper triangle shown in red and the lower triangle shown in blue (step S108). Note that this blinking may, for example, be achieved through a method in which, since the time base display processing is carried out for every 0.1 second, information as to whether or not the indicator 24d has been drawn in previous time base display processing is stored, and the indicator 24d is not drawn this time if it has been drawn the previous time or is drawn this time if it has not been drawn the previous time.

Further, although not indicated in FIGS. 5 and 6, for a price reversal time that has been determined as YES in step S105 (the price reversal time indicated by the indicator 24d in the example in FIGS. 2 and 4), the processing device 12 calculates time from the current time until that price reversal time and causes the display device 15 to display the calculated time in the countdown section 42.

Thereafter, the processing device 12 determines that the current time has not passed the price reversal time indicated by the indicator 24e (step S102) and also determines that that price reversal time is not the closest one to the current time (step S105). Then, the processing device 12 proceeds to step S109. In step S109, the processing device 12 causes the display device 15 to draw the indicator 24e including a pair of vertically aligned triangles in yellow in the indicator display section 21 at a position corresponding to that price reversal time (step S107). For the price reversal times indicated respectively by the indicators 24f, 24g, 24h, 24i, 24j, 24k, 24l, 24m, 24n, and 24o, similar to the indicator 24e, yellow triangles are drawn.

Note that although not indicated in FIGS. 5 and 6, the time base display program has a start time and an end time or a time length of each of the lowest price zone and the highest price zone in the morning session as fixed values. That is, the support system 1 stores, in the storage device 13, information that indicates time periods of the lowest price zone and the highest price zone in the morning session, and the support system 1 displays each indicator 27 in the indicator display section 21 using such information.

The support system 1 uses a timer that is set through the time base display program to carry out the time base display processing shown in FIGS. 5 and 6 for every 0.1 second. Therefore, the time base display form 2 is refreshed every 0.1 second to be visually recognized by the user as if the time base display form 2 is displayed continuously, and the line 25 indicating the current time moves little by little to the right. Then, the indicator 24 which the current time has passed is displayed in black and the vertically aligned triangles thereof are connected to each other with the gray line 26. Of the indicators 24 which the current time has not passed, an indicator 24 that is closest to the current time is displayed with the upper triangle shown in red and the lower triangle shown in blue, and when that indicator 24 is within one minute from the current time, it is displayed to blink. The remaining indicators 24 are displayed in yellow. In addition, as time from the current time until a price reversal timing that is after the current time and indicated by an indicator 24 that is closest to the current time is displayed in the countdown section 42, a countdown to the subsequent price reversal timing is carried out.

As described above, the time base display form 2 can be moved on the display screen 16 as the user carries out a predetermined operation. Specifically, as the user operates a pointing device such as a mouse to place a pointer within a predetermined range on a title bar 29 of the time base display form 2 and left-clicks thereon to drag and drop, the time base display form 2 can be moved on the display screen 16. Since this function is a basic function of a window displayed in Windows including Windows Forms and is widely known, a description on how this function is realized in the support system 1 will be omitted. However, there, for example, is a method in which the time base display form 2 is re-drawn while little by little changing the position where the time base display form 2 is drawn in accordance with a moving amount of the pointer in the display screen 16 from the position at which the predetermined range on the title bar 29 has been left-clicked to the position where it is dropped.

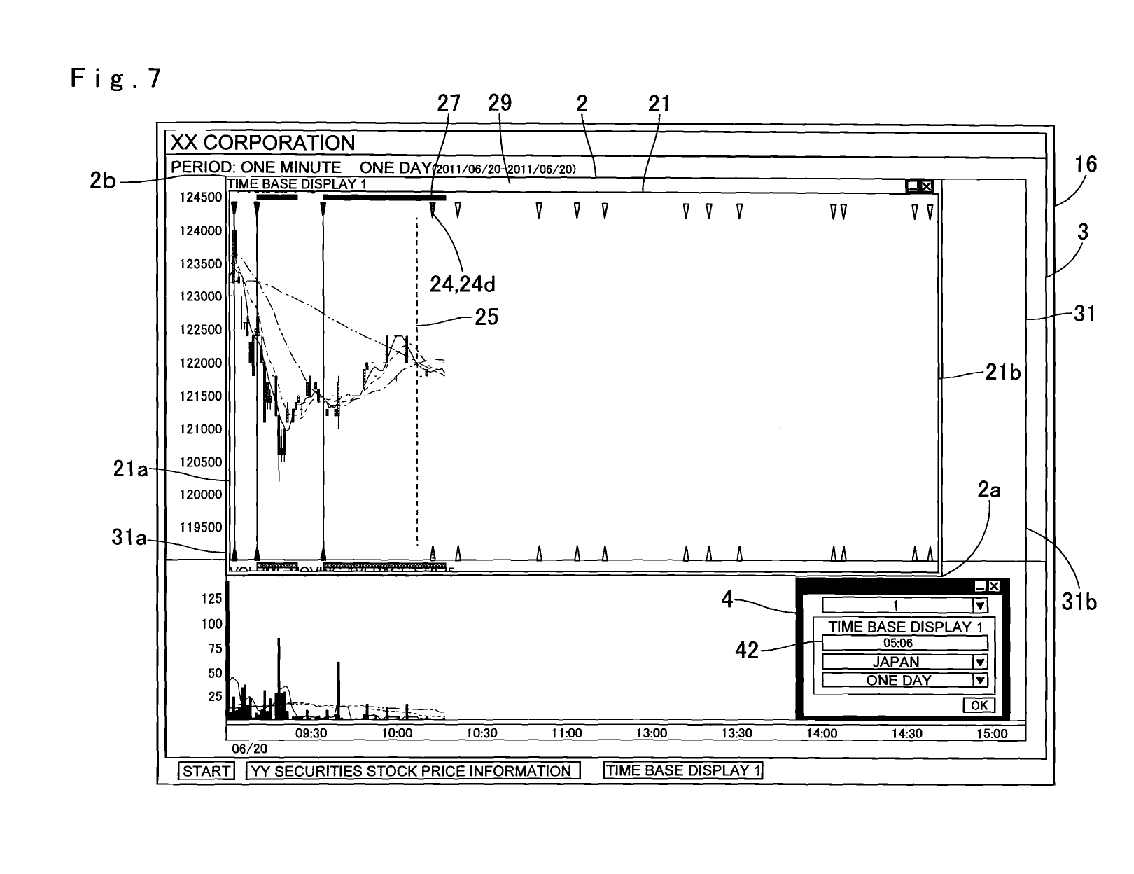

Moving the time base display form 2 in this way causes the display position of the indicator display section 21 on the display screen 16 to change. Accordingly, when the position of the left end 21a of the indicator display section 21 does not coincide with the position of the left end 31a of the chart display section 31 as shown in FIG. 4, moving the time base display form 2 allows the respective positions to substantially coincide with each other as shown in FIG. 7. Thus, the position that indicates the opening time of the stock market in the chart display section 31 can be made to substantially coincide with the position that indicates the opening time of the stock market in the indicator display section 21. Of course, it is also possible to cause the left end 21a and the left end 31a to completely coincide with each other. When the time base display form 2 is moved as well, the support system 1 carries out the above-described time base display processing.

Furthermore, as described above, the size of the time base display form 2 can be modified on the display screen 16 as the user carries out a predetermined operation. Specifically, as the user operates a pointing device such as a mouse to place a pointer at the left end or the right end of the time base display form 2 and left-clicks thereon while a horizontal arrow is displayed to drag and drop, the horizontal width thereof increases or decreases. Further, after placing a pointer at the upper end or the lower end of the time base display form 2, left-clicking while a vertical arrow is displayed to drag and drop causes the vertical width to increase or decrease. Furthermore, after placing a pointer at any one of the four corners of the time base display form 2, left-clicking while a diagonal arrow is displayed to drag and drop causes the vertical width and the horizontal width to increase or decrease simultaneously. Since this function is also a basic function of a window displayed in Windows including Windows Forms and is widely known, the description on how this function is realized in the support system 1 will be omitted. However, there, for example, is a method in which in a case where a lower right corner 2a of the time base display form 2 is left-clicked while the diagonal arrow is displayed and drag-and-dropped, the position of the pointer is calculated every moment while being dragged, and the time base display form 2 is re-drawn while little by little changing the lengths of the time base display form 2 in the horizontal direction and in the vertical direction such that the calculated position lies at the lower right corner 2a and the position of an upper left corner 2b that is an opposite corner does not change. Note that when the size of the time base display form 2 is increased or decreased, the size of the indicator display section 21 within the time base display form 2 also increases or decreases at the same rate.

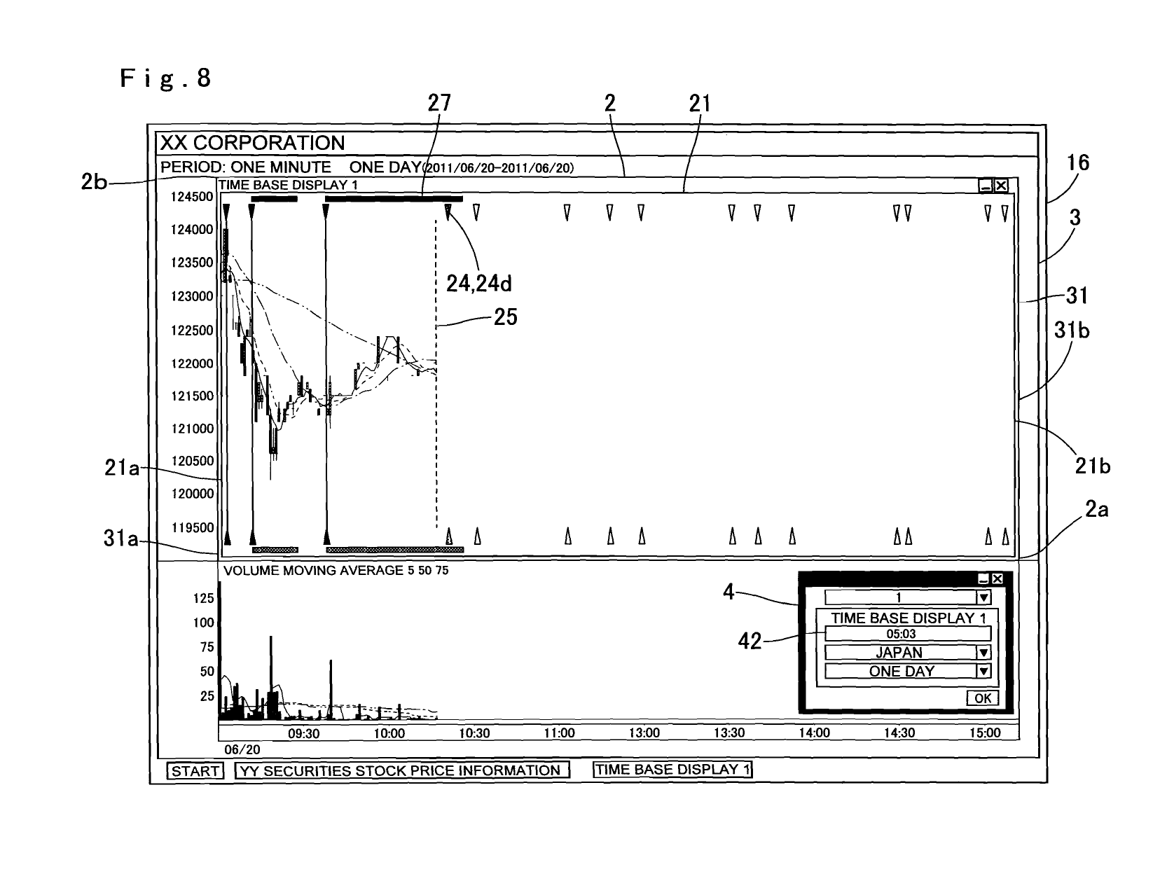

Increasing or decreasing the size of the time base display form 2 in this way causes the size of the indicator display section 21 (the width W and the height H) on the display screen 16 to increase or decrease as well. Accordingly, when the position of the left end 21a of the indicator display section 21 coincides with the position of the left end 31a of the chart display section 31 but the position of the right end 21b of the indicator display section 21 does not coincide with the position of the right end 31b of the chart display section 31 as shown in FIG. 7, enlarging or reducing the time base display form 2 allows the respective positions to substantially coincide with each other as shown in FIG. 8. Thus, the position that indicates the closing time of the stock market in the chart display section 31 can be made to substantially coincide with the position that indicates the closing time of the stock market in the indicator display section 21. In FIG. 8, the width W of the time base display form 2 has been increased and the height H thereof has been decreased from the state shown in FIG. 7. Of course, it is also possible to cause the positions of the right end 21b and the right end 31b to completely coincide with each other. When the size of the time base display form 2 is modified as well, the support system 1 carries out the above-described time base display processing.

Note that when only the display position of the indicator display section 21 is modified, spacing among the indicators 24 and the horizontal length of the indicator 27 do not change. However, when the width W of the indicator display section 21 is increased or decreased, a horizontal (right and left direction) distance between the left end 21a of the indicator display section 21 and the left-most indicator 24a, horizontal spacing among the indicators 24, a horizontal distance between the right-most indicator 24o and the right end 21b of the indicator display section 21, and a horizontal length of the indicator 27 increase or decrease at the same rate as that of the width W.

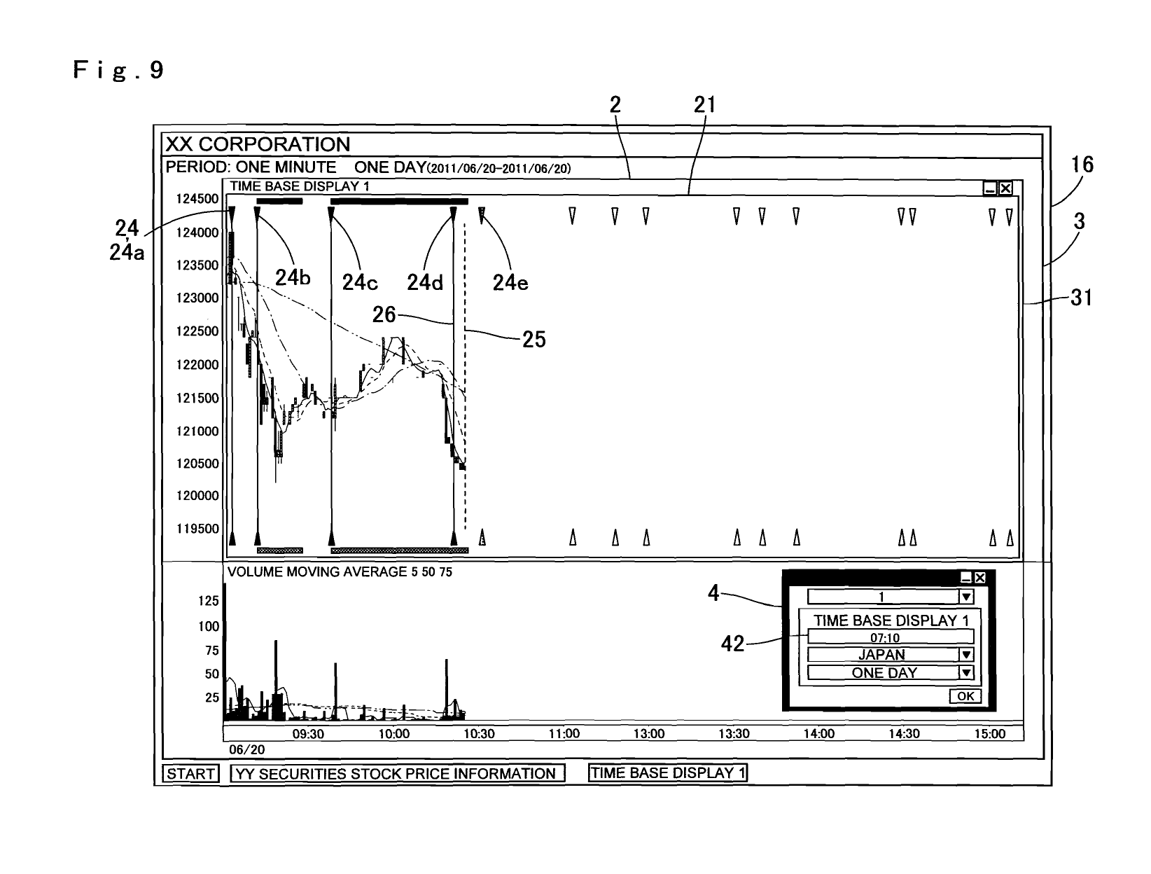

As time elapses from the state shown in FIG. 8 and the current time passes the price reversal timing indicated by the indicator 24d, the support system 1 displays the vertically aligned triangles constituting the indicator 24d in black as in the indicators 24a, 24b, and 24c and displays the line 26 between these triangles. Then, the upper triangle constituting the indicator 24e that is after the current time and that is closest to the current time is shown in red and the lower triangle thereof is shown in blue. The indicators 24 to the right of the indicator 24e are displayed in yellow. Then, time from the current time until the price reversal timing indicated by the indicator 24e is displayed in the countdown section 42. FIG. 9 shows a state where the current time is at around 10:23.

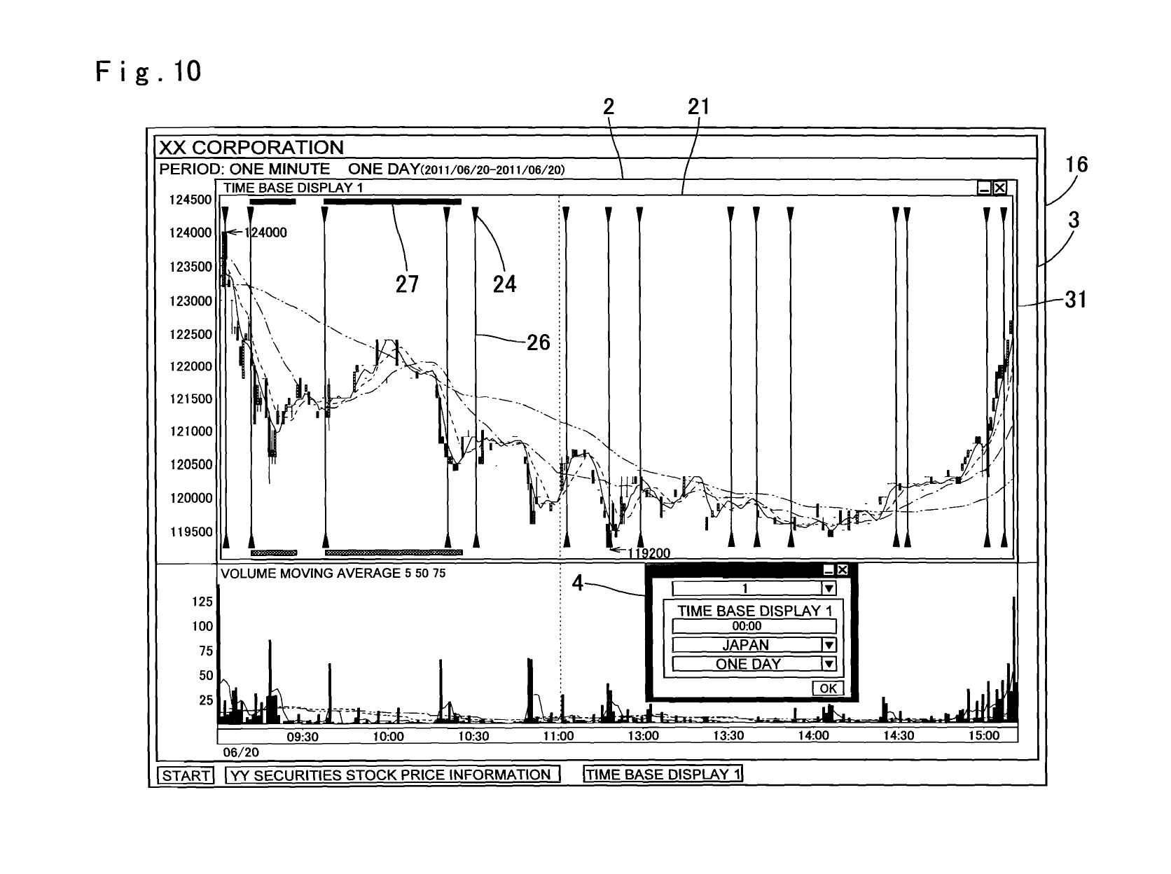

FIG. 10 shows a state where time has further elapsed since the state shown in FIG. 9 and the trading for the day has closed. In this state, in all the indicators 24, the vertically aligned triangles are displayed in black, and the lines 26 are displayed between the triangles, respectively. Further, the line 25 is not displayed.

Subsequently, displaying a plurality of time base display forms 2 and changing a period will be described.

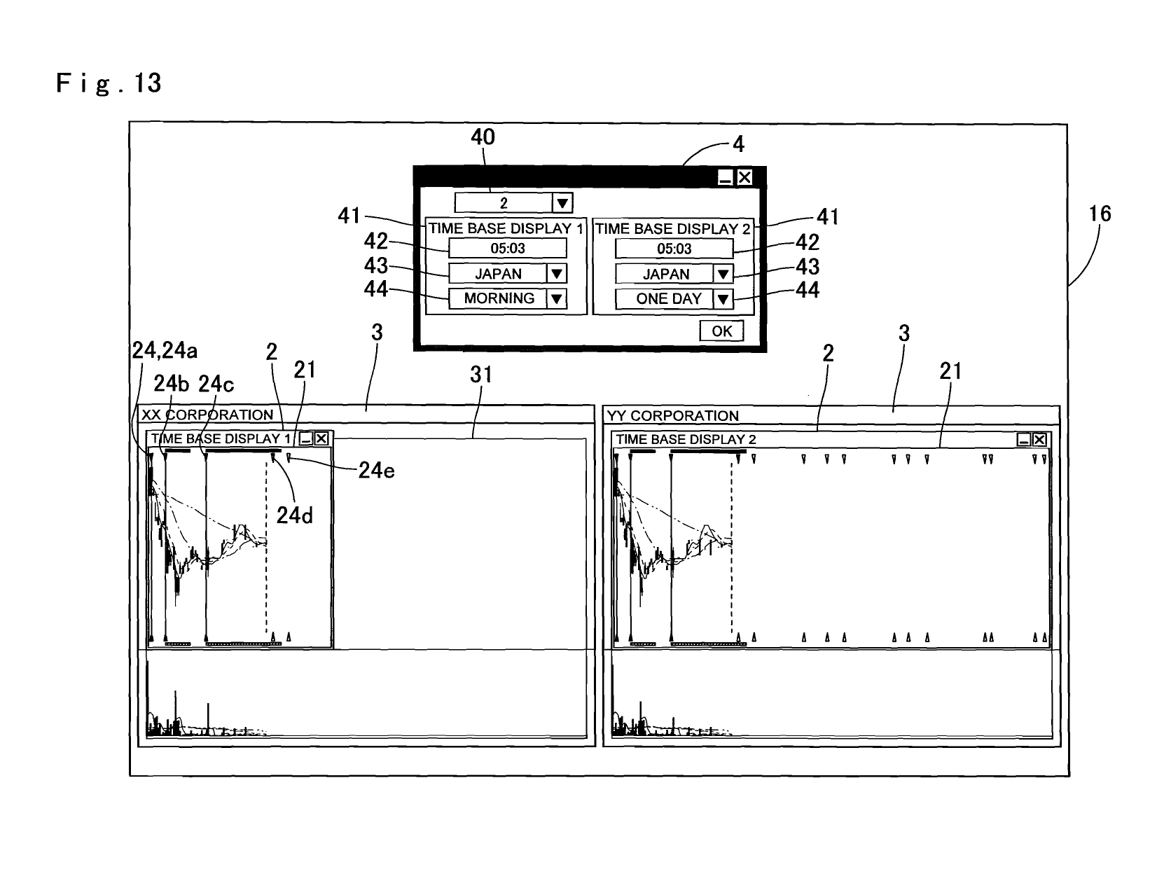

When the user carries out an operation to increase the number of time base display forms 2 to be displayed through the display number selecting section 40 of the menu section 4, the processing device 12 causes the display device 15 to carry out processing to increase the number of the type setting sections 41 of the menu section 4 in accordance with the increased display number as shown in FIG. 12. Further, the processing device 12 carries out the above-described time base display processing to cause the display device 15 to carry out processing to increase the number of the time base display forms 2 to be displayed on the display screen 16 by displaying an additional time base display form 2. FIG. 13 shows a state where two-time base display forms 2 are displayed. Note that titles such as “time base display 1” and “time base display 2” displayed in the respective type setting sections 41 correspond to the titles displayed at the upper ends of the time base display forms 2, and the titles allow the type setting sections 41 to be associated with the respective time base display forms 2.

Further, when the user carries out an operation to change a period through the period selecting section 44 of the menu section 4, the processing device 12 carries out the above-described time base display processing to cause the display device 15 to carry out processing to change the displayed time base display form 2 to a time base display form 2 in accordance with the modified period. Accordingly, when the period is modified from “one day” to “the morning,” the indicator display section 21 is modified such that the left end 21a corresponds to the opening time of the stock market in the morning session, the right end 21b corresponds to the closing time of the stock market in the morning session, the width W corresponds to the trading hours in the morning session, and only the indicators 24a, 24b, 24c, 24d, and 24e of the indicators 24 are displayed. In FIG. 13, the time base display form 2 with the title “time base display 1” is one where the period is set to “the morning.”

As described thus far, according to the support system 1, a stock price chart can be viewed through the indicator display section 21 in which the indicators 24 that indicate the price reversal timings are displayed. Thus, it appears as if the indicators 24 are pasted on the chart, and the price reversal timings are identified with ease, which makes it possible to determine a trading opportunity with ease. For example, the user can speculate that if the opening price starts at a high price, the stock price falls until the next price reversal timing and then turns upward, and the stock price turns downward at the subsequent price reversal timing. On the other hand, the user can speculate that if the opening price starts at a low price, the stock price rises until the next price reversal timing and then turns downward, and the stock price turns upward at the following price reversal timing. Thus, the user can identify a trading opportunity with ease. Note that the stock price chart in the figures are illustrative in nature and differ from an actual stock price chart, and thus the reversal timings do not necessarily match.

In addition, according to the support system 1, the price reversal timings on the time base induced through the above-described finding are displayed in advance with the indicators 24 in the indicator display section 21 that is superimposed on a chart distributed by a securities firm, and the line 25 serving as a guideline to indicate the current time moves within the indicator display section 21 along the time base as a trajectory. Therefore, when the stock price in a one minute bar or the like that moves in real time and the line 25 arrive at a reversal point at the same time, a determination in trading can be made.

The width, the height of the chart display section 31 on which a stock price chart is displayed or the display position of the chart display section 31 on the display screen 16 may vary for each securities firm that is a distributing party, and even with the same securities firm, they may vary depending on the issue. With the support system 1, the size and the display position of the indicator display section 21 can be modified. Therefore, changing the size and the display position of the indicator display section 21 allows the indicator display section 21 to be superimposed on a given chart display section 31 such that the left end 21a coincides with the left end 31a and the right end 21b coincides with the right end 31b. Accordingly, the chart display section 31 can be viewed through the indicator display section 21 in a state where the time base in the chart display section 31 coincides with the time base in the indicator display section 21, which can prevent misjudgment of the timing.

The countdown in the countdown section 42, the movement of the line 25, the color change or the blinking of the triangles constituting the indicators 24 allow the user to notice that the subsequent price reversal timing is approaching, which can prevent the user from overlooking the timing.

Further, the indicator 27 that indicates a timing suitable for locking in profits is also displayed in the indicator display section 21. Therefore, even a novice user who has difficulty in grasping a timing for locking in profits only through the price reversal timings can understand an overall trend of stock prices, where, for example, when the opening price starts at a low price, a time period in which the first indicator 27 is displayed is a crest in the stock price (the highest price zone) and a time period in which the subsequent indicator 27 is displayed is a trough of the stock price (the lowest price zone), and thus the user can lock in profits by trading during these time periods. Furthermore, since the indicator 27 does not indicate a pinpoint but does have temporal duration, it is convenient for the user to use in trading.

In addition, a plurality of time base display forms 2, that is, a plurality of indicator display sections 21 can be displayed on a single display screen 16. Therefore, when multiple charts for respective issues are displayed on a single display screen 16 to trade the respective issues, the indicator display sections 21 can be superimposed on the respective charts.

A period can be selected through the period selecting section 44, and the indicator display section 21 is displayed in accordance with the selected period. Therefore, it is convenient, for example, in a case where the indicator display section 21 is used only for trading in the morning session or in a case where a display region is limited as the plurality of indicator display sections 21 is displayed.

Further, a region can be selected through the region selecting section 43, and the line 25 and so forth in the indicator display section 21 are displayed based on the current time in the selected region. Therefore, the indicator display section 21 can be adopted for trading in a region other than the region where the user resides and also for trading in a plurality of regions by displaying two indicator display sections 21 and designating one to Japan and the other to Hong Kong, or the like.

Note that the support system 1 can be applied to a target for speculation other than stocks and can also be applied to trading within an arbitrary period. Here, although the time base display form 2 may be used commonly for an arbitrary target for speculation and for an arbitrary period, the time base display form 2 may be provided for each target for speculation, or the time base display form 2 may be provided for each applied period. When the time base display form 2 is provided for each target for speculation, the type of the target for speculation may be selected through the type setting section 41. Further, the time base display form 2 may be provided for each region that can be selected through the region selecting section 43.

The shape and the colors of the indicators 24 are not limited to those described above and can be any shape and color that may allow the user to know the timing. Whether or not the indicator 27 is to be displayed and the shape and the color thereof, or whether or not the lines 25 and 26 are to be displayed and the color thereof can also be modified as desired. Further, an indicator that indicates the current time does not necessarily need to be linear as in the line 25, or the indicator that indicates the current time does not need to be displayed. However, displaying an indicator that indicates the current time in the indicator display section 21 makes it easier to visually recognize a relationship between the current time and the price reversal timing as in whether or not there is plenty of time from the current time until the subsequent price reversal timing, which is preferable.

Although an image on which the indicator display section 21 is superimposed does not necessarily need to be a chart, an image that shows a trend of the price of a target for speculation with time on the horizontal axis is preferable in terms of making a determination of a trading opportunity.

Further, in the above-described embodiment, an example has been shown in which the price information is received by accessing a site of a securities firm using a general purpose Web browser to display a chart. However, the price information may be received by using, instead of a Web browser, dedicated software such as “HYPER SBI” (trademark or registered trademark) provided by SBI Securities Co., Ltd. or the like to display a chart.

The current time may be acquired not from the embedded clock but from a Web server that provides the current time. That is, a program that acquires the current time from such Web server via the Internet may be included in the time base display program, and the support system 1 may acquire the current time from such Web server via the Internet. Such configuration makes it possible to acquire an accurate time. Further, there are such Web servers that provide not only Japan Standard Time but also standard times all over the world, and thus the current time in a region aside from Japan can be acquired without calculating.

Furthermore, whether or not to allow the time base display form 2 to be displayed in plurality, whether or not to provide the region selecting section 43 to allow a region to be selected, whether or not to provide the period selecting section 44 to allow a period to be selected, whether or not to provide the countdown section 42, and so forth can also be modified as appropriate.

1. A support system that supports in determining a trading opportunity of a target for speculation, the support system comprising:
a display device that includes a display screen;
a storage device; and
a processing device that is connected to the display device and the storage device and that causes the display device to carry out processing to display an indicator display section on the display screen, the indicator display section displaying an indicator that indicates a price reversal timing within a predetermined period with time on a horizontal axis based on information stored in the storage device indicating the price reversal timing, the indicator display section being configured, when being displayed to be superimposed on another image displayed on the display screen, to allow the other image to be visible through the indicator display section.

2. The support system according to claim 1, further comprising:
a communication device that receives price information of the target for speculation through a communication line,
wherein the processing device is connected to the communication device and causes the display device to carry out processing to display on the display screen an image, as the other image, that shows a trend of a price of the target for speculation within the predetermined period with time on the horizontal axis based on the price information received by the communication device.

3. The support system according to claim 1, wherein the indicator display section is configured such that a size and a display position thereof on the display screen can be modified.

4. A computer readable non-transitory recording medium that has a program recorded thereon, the program causes a computer that includes a display screen to execute:
processing to display on the display screen an indicator display section, the indicator display section displaying an indicator that indicates a price reversal timing within a predetermined period with time on a horizontal axis, the indicator display section being configured, when being displayed to be superimposed on another image displayed on the display screen, to allow the other image to be visible through the indicator display section.

5. The computer readable non-transitory recording medium that has the program recorded thereon according to claim 4, wherein the indicator display section is configured such that a size and a display position thereof on the display screen can be modified.
